(19) United States
(12) Patent Application Publication
(10) Pub. No.: US 2016/0371645 A1
(43) Pub. Date: Dec. 22, 2016

(54) SHIPPING SYSTEM, ACTIVITY BASED COSTING AND DRIVER PRODUCTIVITY USING WEARABLE DEVICES

(71) Applicant: Dicom Transportation Group, Dorval (CA)

(72) Inventors: KIRK SERJEANTSON, Dorval (CA); Vu LE, Dorval (CA); Rayda VILLERROEL, Dorval (CA); Francis LEBEAU, Dorval (CA)

(73) Assignee: Dicom Transportation Group, Dorval (CA)

(21) Appl. No.: 15/187,557

(22) Filed: Jun. 20, 2016

Related U.S. Application Data
(60) Provisional application No. 62/181,553, filed on Jun. 18, 2015.

(51) Int. Cl. G06Q 10/08; H04W 4/02

(52) U.S. Cl. CPC G06Q 10/0833; H04W 4/021

(57) ABSTRACT

Integration of wearable technology into package delivery is provided. Wearable technology such as smart watches can enable improved delivery efficiency by using telemetry information from a telemetry device associated with a delivery vehicle with package information to deliver content to the wearable computing device. The driver can interact with the computing device to provide updates on delivers and track activity to improve costing of packages. In addition the wearable technology can facility improved customer interactions and efficiencies.

### CROSS-REFERENCE TO RELATED APPLICATIONS

This application claims priority from Unites States Provisional Application No. 62/181,553 the entirety of which is incorporated by reference for all purposes.

### TECHNICAL FIELD

The present disclosure relates to transportation of packages and in particular to wearable technology for using transportation of packages.

### BACKGROUND

The process of shipping and delivering packages has many variables in determining appropriate pricing and efficiencies in the delivery process. Providing accurate estimates of shipping time, costing and finding efficiencies in the delivery process has been difficult as data collection is limited in the shipping process. New technologies that are unobtrusive can enable data collection to improve the shipping process. Accordingly, systems and methods that enable improved efficiency of shipping and delivery of packages remains highly desirable.

### BRIEF DESCRIPTION OF THE DRAWINGS

Further features and advantages of the present disclosure will become apparent from the following detailed description, taken in combination with the appended drawings, in which:

FIG. 1 shows a system of wearable technology for delivery services;

FIG. 2 shows as a representation of wearable technology for driver productivity;

FIG. 3 shows as a representation of wearable technology for customer alerts;

FIG. 4 shows as a representation of wearable technology for activity based costing;

FIG. 5 a method of generating content for wearable technology.

It will be noted that throughout the appended drawings, like features are identified by like reference numerals.

### DETAILED DESCRIPTION

In accordance with an aspect of the present disclosure there is provided a method at a server, the method comprising: receiving telemetry information from a telemetry device associated with a delivery vehicle; receiving identification of a package from a handheld computing device; retrieving customer information associated with the identified package from a dispatch database; generating content based upon the telemetry information and the customer information for a wearable computing device; and sending the content to the wearable computing device for display.

In accordance with an aspect of the present disclosure there is provided a system for package deliver, the system comprising: a server coupled to a network, the server including: a network interface; a memory containing one or more databases containing customer and package information; and a processor coupled to the network interface and memory which when executing instructions configure the server to: receive telemetry information through the network interface from a telemetry device associated with a delivery vehicle; receive identification of a package through the network interface from a handheld computing device; retrieve from the one or more databases customer information associated with the identified package; generate content based upon the telemetry information and the customer information for a wearable computing device; and send the content through the network interface to the wearable computing device for display.

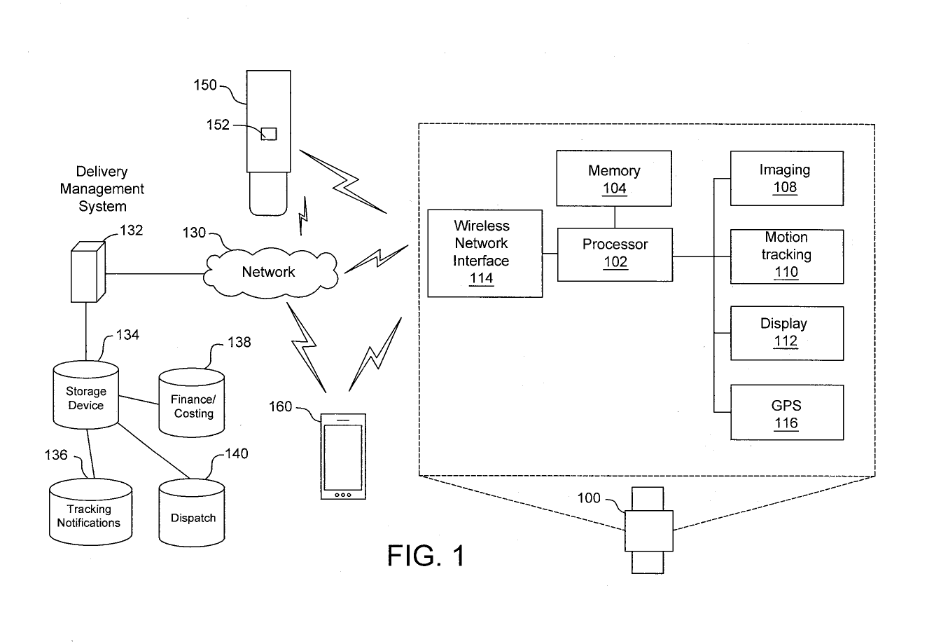

Embodiments are described below, by way of example only, with reference to FIGS. 1-5. FIG. 1 shows a system of shipping management using wearable technology. The system provides wrist-worn wearable computing device such as a smart watch 100 that integrates a processor 102 which interfaces with a memory 104 providing instructions 106 for interfacing with a delivery management system. The processor 102 interfaces with components of the watch 100 such as but not limited to an imaging device 108 such as a camera or scanner, motion tracking sensors 110, a GPS 116 or display 112 to collect and present data on delivery process. A wireless network interface 114 may be provided to connect directly to a local area network (LAN) or wide area network (WAN) 130 to access a delivery management system server 132 having storage 134 for retrieving shipping information associated with transportation process and for providing tracking information from a database structure or utilized a tether or host device to connect to WAN 134. The network interface can also be capable of local or personal area network interfaces such as for example Bluetooth™, IrDA™, Wireless USB™, Z-Wave™, ZigBee™, Body Area Network™, IEEE 802.3, 802.11, 802.15 standards or by other types of wireless technologies. The wearable computing device may interface with telemetry systems of a delivery vehicle 150 or a handheld computer or a handheld handheld mobile device 160 such as a smart phone, handheld scanner, or data acquisition device to send and receive data through the network. The watch 100 may containing the imaging device 108 and GPS 116 or may utilized the components of the handheld handheld mobile device 160.

The delivery vehicle 150 can also include a telematics device 152 providing information such as GPS information, idling, hard breaking, and engine diagnostics such as through an ODBII interface. The information provided by the telematics device 152 can be sent to the data management system 132 which can be provided to the wrist worn wearable device 100. The delivery vehicle 150 may also provide a wireless LAN for receiving data from the wrist worn wearable device 100 and communicating the delivery management system 132. The delivery management system 132 comprises a one or processors and non-transitory memory that may reside on a server or be in a distributed computing architecture system comprises multiple computing devices and storage devices. The memory of the system 132 can provide instructions for interfacing with telematics information of the vehicle, the handheld mobile device 160, wearable computing device 100 such as a smart watch and package tracking infrastructure. The delivery management system 132 can track shipments, driver locations, customer locations, and activity events associated with a driver and particular packages and be utilized for costing or finance database 138 for attributing driver activity to effort required to deliver a package. The delivery management system 132 may also generate routing information or update routing information to the smart watch 100 derived from dispatch data 140. The delivery management system 132 also provide tracking and notification instructions and database 136 for determining when delivery notifications are generated to the smart watch 100.

Smart watches, such for example but not limited to the Apple Watch™, Samsung Gear™, Motorola Moto 360™, etc. can be used as pedometers and to calculate movement and steps or effort involved to deliver a package, send and receive notifications.

The present technology uses communicating via alerts in a machine to machine environment to leverage some of that work in the transportation environment. Other wearable computing device may integrate with or alternatively be implemented in glasses, headsets, earphone or clip on devices may be contemplated. The smart watch 100 tethers to the handheld mobile device to retrieve or provide data related to location, destination, timing, and delivery information and may also utilize sensor information from the handheld mobile device 160 to improve or augment accuracy.

There are several issues solved by the implementation of this technology. They can be put into three groups, driver productivity, and customer alerts and activity based costing.

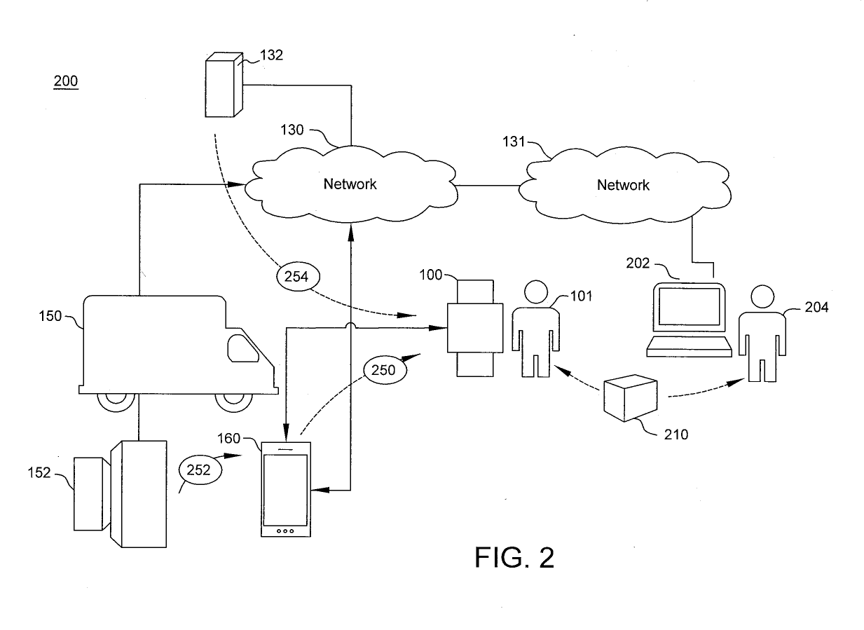

Referring to FIG. 2 shows a system 200 of utilizing wearable technology by a courier. There are some daily processes in a courier driver's day that can be improved by the introduction of wearable technology, specifically the inclusion of a smart watch. Leveraging a smart watch 100 the driver 101 can receive pickup alerts as well as other alerts from dispatch to a customer 204 through a smart watch to pick up or deliver a package or letter 210. This reduces the impact of distracted driving. Also, by leveraging a smart watch connected to the driver's telematics device, the driver 101 can get real-time alerts from vehicle diagnostics to warn of idling issues or other issues that affect their day.

Smart watch 100 connects into the driver's mobile scanner 160 (250). Mobile scanners 160 in turn takes outputs from the on board telematics device 152 and from the dispatch system 132 (252). Smart watch receives alerts from the mobile scanner 160 when an incoming dispatch is coming in from the dispatch group of the delivery management system 132 (254). The driver 101 can accept or reject dispatches while driving using the controls on the watch. Handheld mobile device 160 receives telematics data and compiles for driver, sends data to watch for driver consumption, collects other data such as: stop information, special instructions for delivery and delivery contact information.

The watch 100 identifies to the driver 101 when excessive idling occurs, hard breaking or other driver influenced deviations occur from driving standards. Law may requires drivers to pull over and read dispatches on their handheld mobile device 160. By using a smart watch 100 the driver can more easily check dispatches while walking or driving. Driver can also provide one touch responses to communication from dispatch. The smart watch (wearable device) is leveraged to assist the driver in being more efficient during his/her day. The watch provides a safe and easy way to respond to customer service, dispatch and the customer through the watch interface.

The smart watch 100 can display telematics alerts on watch 100 that have immediate impact on driver 101. The delivery management system 132 can also provide a “gamefied” interaction such that a driver gets input and a score for comparison against other drivers. The watch 100 receives pick up alerts and displays to driver 101. The watch 100 may also receive expectations based upon driving conditions or previous deliveries or pickups as to expected or desired times. Driver 101 can one touch response “yes” or “no” using watch buttons. Driver can receive questions from customer service through the watch and respond with “pre-written” answers to provide information such as expected arrival times or special delivery instructions. The customer 202 can interact through a computing device 202 to send and receive delivery request information through a network 131.

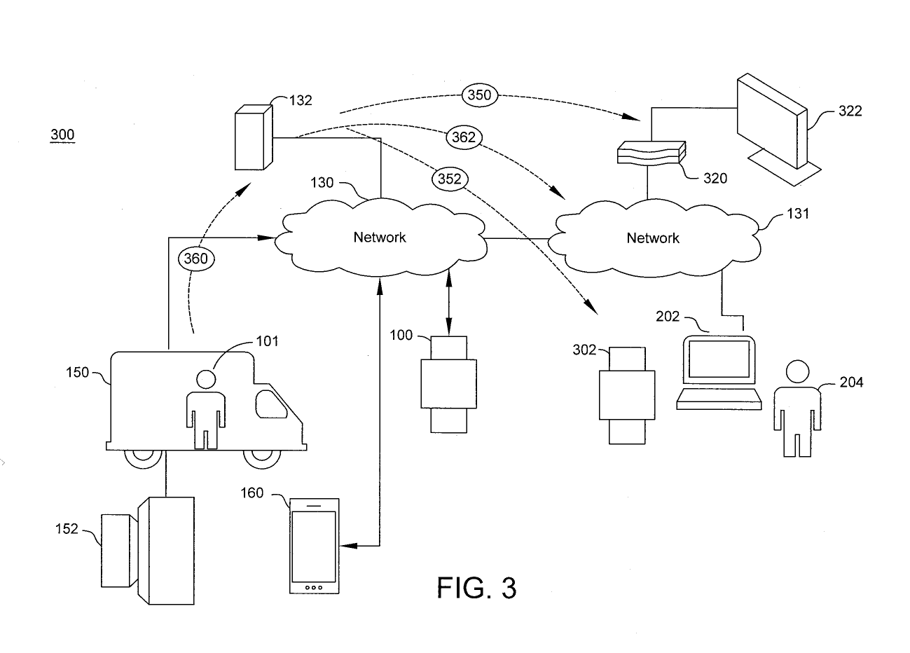

Referring to FIG. 3, a system 300 for enable interaction with customers is provided. Customers in a transportation environment work hard to ensure all packages are ready for pickup. Leveraging a smart watch integrated into a shipping system the customer can get alerts on when a driver will arrive helping process packages in time to make driver cut-off times. The customer 202 can also be alerted of other issues and impacts that can make their day more efficient.

The information being sent to the customer shipping system, at for example a shipping warehouse, and displayed both on the smart watch 302 and onto a computing device 320 providing a display 322 output such a monitor. The computing device 320 can be a media device such as for example Apple™ TV, or integrated into a television or smart TV. The watch 302 alerts the user on critical shipment updates and when the driver 101 is set to arrive in the building. This allows the driver to better prepare during the day and help drive better productivity. Customer receives alerts on shipping system of impending driver pickup/delivery (350). Information can also be sent to watch 302 to alert customer of driver arrival and countdown to arrival (352). The computing device 320 receives tracing information from the shipping system which is receiving information from the delivery management system 132 and displays information from the shipping system on a large screen monitor. The information includes but is not limited to reports from shipping system, delivery status of shipments shipped previous day, shipment information for current day including total shipments processed and total cost. Watch 302 can also provide a count of pieces shipped so far that day and total cost of shipments processed and can also provide alerts for shipments delivered that day or special shipments requested for delivery detail through the track and trace system via the integration services.

The operating principal behind this is a direct link between the shipping system and the computing device 320 and the smart watch 302. The small application resides within the shipping system to foster communication to both devices and ensure alerts and updates are sent in a timely manner. The customer watch connects into the onsite shipping system, could be via the website, thick client application or smart phone shipping application.

The smart watch 100 can enable the driver to provide notifications or easy interactions with the delivery management system 132 (360). For example the smart watch 100 can enable customers to receive updated delivery estimates directly from the driver. For example if customer service sends a message such as “when will you delivery to company x” the driver will have options on his/her watch they can choose such as: 10 minutes, 30 minutes, 1 hour, or can scroll down and pick a time. This information can be sent back to the customer 202. Alternatively dispatch can send a message “can you pick up at company y” the driver can respond “yes” or “no” by pushing buttons on their watch which can provide notification of a delivery time. If a driver is on his/her way to pick up or deliver a package they can send notifications to the customer shipping system or smart phone that “they are on their way” or “need entry to building.” (362)

The system 300 can also enable the sending of customer alerts to a smart watch 302 is a big advantage in warehouses where single operators perform pick/pack and shipping operations. Having a communication to a smart watch allows operators to be mobile within their warehouses while at the same time receive important information about the pickup and delivery process.

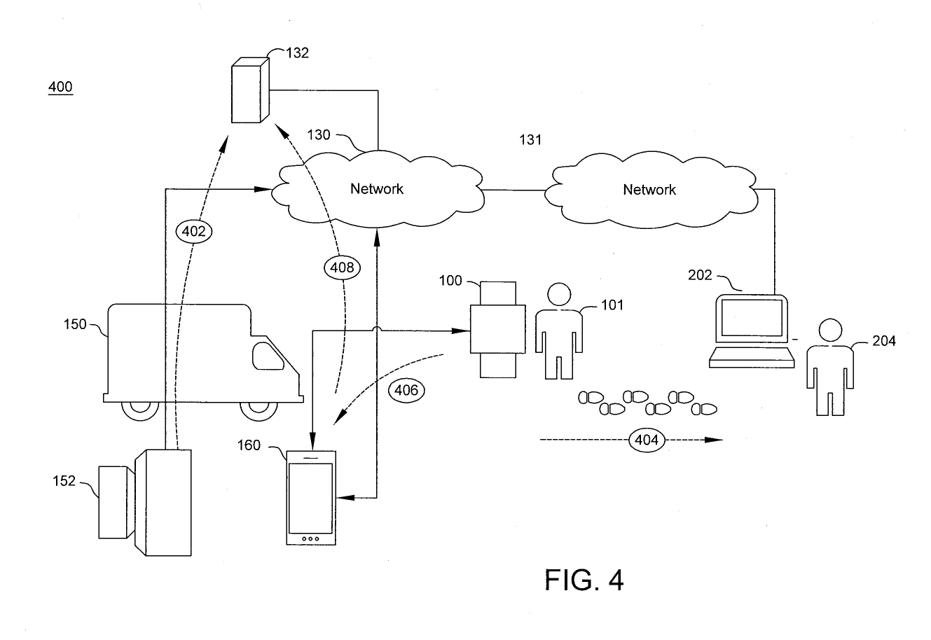

Referring to FIG. 4, a system of activity based costing is shown. Currently costing for a customer will take into account drive times and in some cases densities (how many customers are in their area). With the introduction of a smart watch 100 finance can gather more detail on a driver activity for a specific customer to ensure the costing properly reflects the efforts by the driver. The technology disclosed integrates a smart watch 100 with various applications to provide operational benefits to transportation companies and the customer. The watch 100 integrates with the handheld mobile device 160 and on board GPS 152 to assess the work effort when delivering a package. When a delivery vehicle 150 pulls into a customer 202 and stops the system makes an event (402). The system can use geo-fencing to measure “time to park” from entering the companies property to parking so the driver can unload freight or pickup freight. The unit then tracks the physical movements of the employee delivering the package as recorded on the watch (404). The pedometer in the watch measures the steps from the truck to the shipping system. It also records and wait times or idle times during the physical trip. The unit tracks physical movements from collecting the freight to delivery. This information is recorded and sent back to the handheld mobile device (406). The handheld mobile device can then upload the activity information required for the package to the delivery management system 132 (408). The costing of the delivery can then be adjusted or used to determine future costs and stored in a database 138 and used for pricing when dispatching 140 to customers.

Today costing information is based on high level information about freight size, pick and destination information. By using a smart watch 100 finance calculations can get more detailed on where costs affect profitability. For example, if a driver has two deliveries that charge the customer the same amount, yet one delivery requires the driver to scale 4 flights of stairs, walk down a long hallway and make four delivery stop. If the other delivery stop requires the driver to take 10 steps into a warehouse and delivery the package, both stops should not be charged the same price. The activity based tracking can provide dynamic pricing based upon the effort requirements of the delivery.

Activity based costing leverages the technical information coming from telematics, the handheld mobile device and the smart watch to provide more information through the cloud information technology (IT) integration services to the rating department to understand if customers should pay a higher rate for more complex deliveries. The telematics can provide information from the time the customer enters a company's property to the time he/she parks (geo fencing+engine information)—this is important for determining wait times for dock doors. The handheld mobile device 160 can determine the start and end of a delivery. The smart watch 100 using a pedometer can determine footsteps, stops and wait times to complete a pickup and/or delivery. Alternatively energy expenditure such as calorie burn may be determined and utilized in the calculation. All this information is combined to understand if a customer should pay more or less for services provided. The smart phone 160 reconciles these pickups against what is scanned. If a shipment is missing the driver 101 is alerted via the watch 100. The activity based costing model takes input from all three devices (accepts the watch information through the handheld mobile device).

The system 400 assesses bands within the process to see if there are durations that sit outside normal expectations—examples include long wait times from entering property to parking, long distances walked from truck to customer, long wait times in building while waiting for customers to prepare or receive packages. Customer rates are assessed and increased or decreased based on information.

The operating principal behind this solution is that the watch 100 interfaces with the handheld mobile device 160. The handheld mobile device 160 pulls information from the delivery management system 132 for dispatch to the watch 100. The watch 100 in turn sends information back to the handheld mobile device 160 which then sends up to the delivery management system 132. The watch 100 can also interface directly with the customer shipping system when in range.

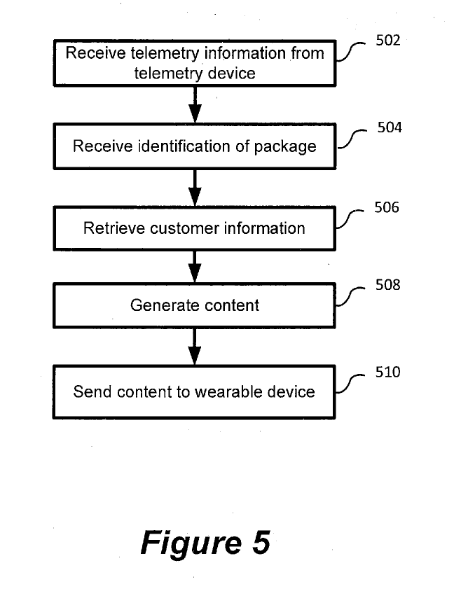

FIG. 5 a method of generating content for wearable technology. The server receives telemetry information from a telemetry device associated with a delivery vehicle (502). Identification of a package from a handheld computing device is received at the server (504). Customer information associated with the identified package from a dispatch database (506). Content is then generated based upon the telemetry information and the customer information for a wearable computing device (508). The content is sent to the wearable computing device for display (510). The server can comprise one or more computing devices or processors coupled through a network. The portions of the associated databases may resided on a storage device or be distributed to multiple storage devices or databases.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, BIu-Ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A method at a server, the method comprising:
receiving telemetry information from a telemetry device associated with a delivery vehicle;
receiving identification of a package from a handheld computing device;
retrieving customer information associated with the identified package from a dispatch database;
generating content based upon the telemetry information and the customer information for a wearable computing device; and
sending the content to the wearable computing device for display.

2. The method of claim 1 wherein the wearable computing device is a wrist-worn computing device providing smart watch functionality.

3. The method of claim 2 wherein the wearable computing device is associated with a driver of the vehicle.

4. The method of claim 3 wherein the wearable computing device receives the content through the handheld computing device.

5. The method of claim 1 further comprising receiving activity information from the wearable computing device associated with the delivery of the package, wherein the information is utilized to determine a cost associated with the delivery of the package.

6. The method of claim 5 wherein the information comprises one or more of a number of steps, a number of flights, and a number of calories expended.

7. The method of claim 5 wherein the activity information comprises a time metric determined at a customer's premises.

8. The method of claim 7 wherein the time metric is determined from geo-location information associated with the customer premises.

9. The method of claim 1 wherein the telemetry information comprises one or more of GPS information, idling, braking and engine diagnostics.

10. The method of claim 1 wherein the content identifies an estimated delivery time for the package.

11. The method of claim 1 wherein the dispatch database identifies a customer, a customer address and package information.

12. The method of claim 1 further comprising sending the content to a computing device coupled to a display at a customer premises associated with the customer information.

13. The method of claim 1 further comprising retrieving delivery information associated with one or more additional packages on the vehicle from a dispatch database for generating the content.

14. A system for package deliver, the system comprising:
a server coupled to a network, the server including:
a network interface;
a memory containing one or more databases containing customer and package information; and
a processor coupled to the network interface and memory which when executing instructions configure the server to:
receive telemetry information through the network interface from a telemetry device associated with a delivery vehicle;
receive identification of a package through the network interface from a handheld computing device;
retrieve from the one or more databases customer information associated with the identified package;
generate content based upon the telemetry information and the customer information for a wearable computing device; and
send the content through the network interface to the wearable computing device for display.

15. The system of claim 14 wherein the wearable computing device is a wrist-worn computing device providing smart watch functionality.

16. The system of claim 15 wherein the wearable computing device is associated with a driver of the vehicle and the wearable computing device receives the content through the handheld computing device.

17. The system of claim 14 further comprising receiving activity information from the wearable computing device associated with the delivery of the package, wherein the information is utilized to determine a cost associated with the delivery of the package.

18. The system of claim 17 wherein the information comprises one or more of a number of steps, a number of flights, and a number of calories expended.

19. The system of claim 17 wherein a time metric is determined from geo-location information associated with a customer premises.

20. The system of claim 14 further comprising sending the content to a computing device coupled to a display at a customer premises associated with the customer information.
